(19) United States
(12) Patent Application Publication
(10) Pub. No.: US 2004/0005406 A1
(43) Pub. Date: Jan. 8, 2004

(54) Metal coating method and metal-coated material

(76) Inventors: Koichi Niihara, Osaka (JP); Yong-ho Choa, Osaka (JP); Yamato Hayashi, Kyoto (JP)

Correspondence Address: WENDEROTH, LIND & PONACK, L.L.P., 2033 K STREET N. W., SUITE 800, WASHINGTON, DC, 20006-1021, US

(21) Appl. No.: 10/406,244

(22) Filed: Apr. 4, 2003

Related U.S. Application Data
(63) Continuation of application No. 10/169,506.
Application No. 10/169,506 is a 371 of international application No. PCT/JP00/09350, filed on Dec. 27, 2000.

(30) Foreign Application Priority Data
Jan. 6, 2000 (JP) 2000-005810

(51) Int. Cl. B32B 15/16

(52) U.S. Cl. 427/190; 428/546; 428/469

(57) ABSTRACT

Metal coating is performed by dispersing powders of an inorganic compound in a liquid containing an organic solvent and irradiating vibration or applying heat in a state in which a substrate is immersed in the liquid to form a metallic film on the substrate. By this, provided are a novel method which can uniformly coat the metallic film on various types of arbitrary substrates with a thickness on the order of from several nanometers to several thousand nanometers by a simple means without requiring a need for a means having such a multiple of restrictions as in the vacuum system, without caring about generation of a noxious gas or the like, and free from any restriction on a heating temperature or a selection of a material, and a material coated with a metal by this method.

### TECHNICAL FIELD

The present invention relates to metal coating methods and materials coated with metals. More particularly, the present invention pertains to a novel method which is capable of coating various types of substrates with metals and a material which is coated with a metal by this method.

### BACKGROUND ART

As methods of coating with metals, various types of methods such as a vacuum vapor deposition method, a chemical vapor deposition (hereinafter also referred to as CVD) method, a physical vapor deposition (hereinafter also referred to PVD) method, an electric plating method, a spin coating method, a fusion method and the like have been put to practical use. However, some problems can be found in each of these methods. For example, in the vacuum vapor deposition method, it is necessary to maintain an entire system in such a high vacuum as 10⁻² Pa or more and, moreover, since the method uses a vapor deposition technique, a size or a shape of a material to be coated has been limited to some extent. Further, since the CVD and PVD methods ordinarily employ a vacuum system, there are same problems as in the vacuum vapor deposition method. In the CVD method, since a substrate is heated to a high temperature, it has been necessary to select the substrate which is neither decomposed nor deformed at a high temperature. Though many improved methods utilizing a low-temperature process have been put to practical use, a reaction temperature is, nevertheless, fairly high, say, as high as from 500° C. to 1000° C. or higher. Further, there are some cases in which a noxious gas is used depending on a type of metal to be used for coating. In the PVD method, since a particle which comes to be a starting material of vapor deposition has a character to become a beam, it is difficult to apply a uniform coating on the substrate having a highly rough surface and, moreover, it is substantially impossible to apply coating on a multiple of substrates at a time. Though the electric plating method is only one effective method to form a metallic film at normal temperature, there was a drawback that a noxious substance such as a chlorine gas is generated or the method can not be applied for a substrate which is an insulator. Since the spin coating and fusion methods each immerse the substrate in a molten metal, these methods also have a problem that these methods are limited to a case in which a melting temperature of the metal is lower than a melting point, decomposition temperature or deforming temperature of the substrate.

### DISCLOSURE OF INVENTION

Under these circumstances, as a means to solve the above-mentioned problem, the present invention provides a method which is capable of uniformly coating substrates having a various types of qualities and shapes with a metal without requiring a need for special equipment and means which have many restrictions attributable to a vacuum system and free from severe conditions such as a limitation on a heating temperature and a selection of a material, and the material which is coated with the metal by this method.

Namely, the invention of this application provides an invention as described below.

Firstly, the invention of the present application provides a metal coating method characterized by comprising the steps of: dispersing powders of an inorganic compound in a liquid containing an organic solvent; irradiating vibration or applying heat in a state in which a substrate is immersed in a liquid; and forming a metallic film on the substrate.

Secondly, the present invention provides the above-described metal coating method wherein a liquid temperature is from 0° C. to 500° C.

Thirdly, the present invention provides the metal coating method wherein the organic solvent is an organic solvent which has a reducing property to the inorganic compound.

Fourthly, the present invention provides the metal coating method, wherein, after the vibration was irradiated or the heat was applied, the substrate is removed from the liquid and, then, heated to stabilize a metallic film.

Fifthly, the present invention provides the metal coating method, wherein the substrate is a metal (alloy) in bulk form or powder form, ceramics or an organic substance.

Sixthly, the present invention provides the metal coating method, wherein the inorganic compound is rich in reducing property to metals.

Seventhly, the present invention provides the metal coating method, wherein the inorganic compound is a reducing compound.

Eighthly, the present invention provides a material coated with a metal characterized by being produced by any one of the first to seventh methods of the invention described above.

Ninthly, the present invention provides the material coated with the metal, wherein a coated metal film is a functional film.

### BRIEF DESCRIPTION OF DRAWINGS

FIG. 1 shows a flow chart illustrating a metal coating method according to the present invention;

FIG. 2 illustrates an X-ray diffraction pattern of a coating film of SiO₂ ceramics coated by a method according to the present invention;

FIG. 3 illustrates a relationship between an irradiation time of an ultrasonic wave and film thickness in a metal coating method according to the present invention;

FIG. 4 illustrates a TEM image of BaTiO₃ dielectric ceramic powders which have been coated by a method according to the present invention;

FIG. 5 illustrates a TEM image of ZnO varistor ceramic powders which have been coated by a method according to the present invention;

FIG. 6 illustrates an X-ray diffraction pattern of coating films, in a case in which irradiation conditions of an ultrasonic wave are changed in a method according to the present invention;

FIG. 7 illustrates an HRTEM image of powders obtained by irradiating an ultrasonic wave on PdO powders; and

FIG. 8 illustrates an X-ray diffraction pattern of metal powders obtained in a case in which water is used as a solution and Ag₂O is used as powders of a metal oxide.

### BEST MODE FOR CARRYING OUT THE INVENTION

The invention of this application has characteristics as described above and embodiments thereof will be described below.

Firstly, in a metal coating method to be provided by a first invention of this application, powders of an inorganic compound are dispersed in a liquid containing an organic solvent and, then, vibration is irradiated or heat is applied in a state in which a substrate is immersed to form a metallic film on the substrate.

In the method according to the present invention, the vibration is irradiated or the heat is applied in a state in which the substrate is immersed in the liquid containing the organic solvent in which the powders of the inorganic compound are dispersed and, on this occasion, as the vibration, mentioned as a representative example is an ultrasonic wave which, for example, is generated by an apparatus for converting electric vibration into mechanical vibration, an actuator or the like.

In the present invention, the metallic film is formed by irradiating these types of vibration or applying heat and, on this occasion, the metallic film is formed by reducing the inorganic compound and it is considered that the organic solvent, and vibration or heat contribute to such a reduction.

It is permissible that either the vibration or heat is first irradiated or applied to the liquid containing the organic solvent in advance and, then, the substrate is immersed in the liquid, or, after the substrate is immersed in the liquid, the vibration or heat is irradiated or applied to the liquid.

On this occasion, as the organic solvent, an organic solvent which has a reducing property to the inorganic compound is favorably used. Various types of organic solvents, for example, alcohols such as ethanol, butanol and the like, amines such as diethyl amine, butyl amine and the like are illustrated. These organic solvents may form an aqueous phase individually or in any combination thereof and, further, may be used as a mixture with water or the like or as an aqueous solution or the like. When the organic solvent is used as an aqueous solution, a concentration of the organic solvent therein is in a range of, ordinarily from 0.5% by weight to 99.5% by weight, and more preferably from 70% by weight to 99.5% by weight.

As for the inorganic compound to be dispersed in the liquid, an inorganic compound which is rich in a reducing property to the metal is favorably used. As for a type of the metal, various types of metals, or metals having anyone of magnetism, an optical function and any other functions are permissible whereupon the metal which constitutes a compound in such a state as is more easily reduced to a constituting metal than the substrate in a liquid containing organic solvent is preferable. For example, illustrated are oxides such as silver oxide, palladium oxide and the like and, among other things, illustrated is a salt of an inorganic acid or a salt of organic acid such as a noble metal oxide, a metal nitrate, a metal oxalate or the like. Further, a particle diameter of powders of these inorganic compounds is not particularly limited, but powders having an average diameter of from several μm to dozens of μm are preferably used.

A reducing radical can be generated by irradiating the vibration on or applying the heat to the reducing organic solvent such as alcohol or the like. Further, the inorganic compound is reduced by the thus-generated reducing radical to generate a metallic ion such as a silver ion and/or a cluster. It is considered that the thus-generated metallic ion and/or cluster is attached on the substrate to form a metallic film. This reduction reaction can easily be promoted by heating to some extent whereupon the reduction reaction can be controlled at an exceedingly low temperature compared with a known method. Furthermore, a quantity of the metallic ion and/or cluster to be generated can also be controlled by conditions such as an output of the ultrasonic wave, a period of irradiation time and the like. By these features, the metallic film which is so controlled as to have a thickness on the order of from several nanometers to several thousand nanometers can be formed on the substrate in a uniform manner.

Still further, morphology of a metallic film to be formed is not particularly limited, but it may be any one of a polycrystalline film made of particles having a diameter of 1 nanometer or less, or several thousand nanometers, an oriented film in which crystalline orientations are aligned, a monocrystalline film and, moreover, a film having an amorphous structure depending on generation conditions.

In the method according to the present invention, a substance which is coated with the metal, that is, the substrate is not make any distinction according to a quality or a shape. In other words, the quality thereof may be a metal, an inorganic material such as ceramics, or an organic material such as plastic, while the shape thereof may be plate form as a matter of course, of a curved surface, of a rough surface or powder form.

More specifically, in the metal coating method according to the present invention, it is appropriate that, firstly, the substrate is rinsed with an appropriate solvent to remove a foreign matter or an oxide film adhered to a surface thereof and, then, immersed in a liquid containing an organic solvent and, thereafter, the liquid is added with inorganic compound powders. It is important that, in order to uniformly coat the substrate with the metal, a surface of the substrate is rinsed to be in an active state.

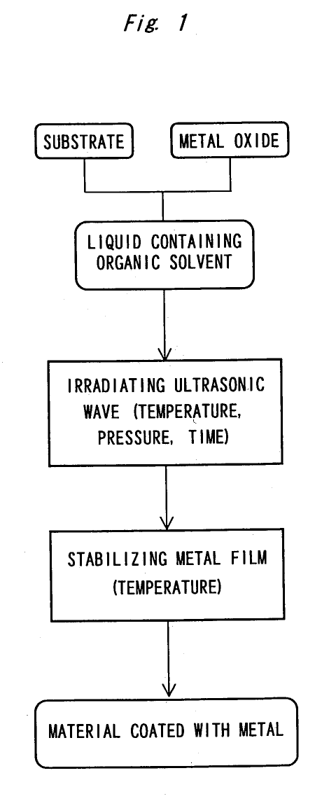

It is permissible that a portion or a total of a dispersed inorganic compound is in a dissolved state. For example, as illustrated in a flow chart of FIG. 1, vibration such as the ultrasonic wave or the like is irradiated on or heat is applied to the liquid containing the organic solvent in which such an inorganic compound is dispersed and a part of the substrate, that is, a region or a portion of the substrate to be coated is immersed at a desired temperature, ordinarily, in a wide range of from 0° C. to 500° C., and more preferably in a range of from about 20° C. to about 60° C. In a case of the ultrasonic wave, as for irradiation conditions thereof, an output is preferably from about 100 KW to about 1000 KW, a frequency is preferably from about 20 kHz to about 2 MHz and a period of irradiation time is from several seconds to several hours, and preferably from about several minutes to about dozens of minutes. Film thickness of the coating metal to be formed can be controlled by conditions of, for example, the output and the period of irradiation time of the ultrasonic wave, the temperature, and the like. Moreover, the substrate on which a metallic film is formed is removed from the liquid and is allowed to stand at a temperature of appropriately from about 20° C. to about 1000° C. for from several minutes to several days, and more preferably from several hours, to dozens of hours to stabilize the adhesion of the metallic film on the substrate.

Further, as for a method of rinsing the above-described substrate, for example, the substrate is immersed in alcohol and, then, irradiated by the ultrasonic wave to rinse it. Furthermore, when the metallic film is stabilized on the substrate, the substrate is allowed to stand in a heating device to stabilize the metallic film.

While the morphology or the film thickness of the metallic film formed on the substrate by the method according to the present invention as shown in FIG. 1 is controlled in respective prescribed manners, it is characteristic that the method according to the present invention is, for example, capable of uniformly forming the metallic film having a thickness on the order of from several nanometers to several thousand nanometers on the substrate.

According to the method according of the present invention, the metallic coating can be performed by a simple process as described above. Further, it is not necessary to use the noxious gas and there is no generation of the noxious gas as in the conventional method and, accordingly, metallic coating can be performed in an open system. Furthermore, coating can be performed at a lower temperature than in the conventional method and, since the method according to the present invention does not ask for the particular quality and shape of the substrate, the method can be applied to not only metallic material, but also a material having high thermoplasticity such as plastic and the like, a ceramic dielectric material or a piezoelectric material, a semiconductor material and the like. Still further, the method can also be applied to a plurality of substrates having a complicated shape, in powdery form and the like.

These features make it possible to perform the metallic coating simply and at a low cost whereupon it can be expected that the method according to the present invention is utilized not only in various industrial fields of from electric and electronic fields to an agricultural field, but also a medical field or various phases of living environments.

Moreover, according to the invention of the present application, by the above-described method, various types of substrates and materials comprising these substrates and metallic films coated thereon are provided.

For example, a functional material such as a material having a metallic film which is of a magnetic metal and the like is provided.

Hereinafter, embodiments according to the present invention are shown along with the accompanying drawings and the embodiments are described in more detail.

### EXAMPLES

### Example 1

An SiO₂ ceramic plate and an Si semiconductor wafer were each individually used as a substrate. Ag₂O powders having a particle diameter of about 2 μm were used as powders of a metal oxide.

Firstly, the SiO₂ ceramic plate was rinsed with ethanol and, then, immersed in ethanol and added with Ag₂O powders. Thereafter, the resultant ethanol aqueous solution was heated up to 60° C. and, then, irradiated by an ultrasonic wave of 500 W and 38 KHz. On this occasion, in order to evaluate a relationship between a period of irradiation time of the ultrasonic wave and thickness of an Ag coating film to be formed, the period of irradiation time was changed in a range of from 1 minute to 180 minutes.

Thereafter, the SiO₂ ceramic plate was removed from the solution and allowed to stand in a heating device for 30 minutes at 100° C. to stabilize a coating film.

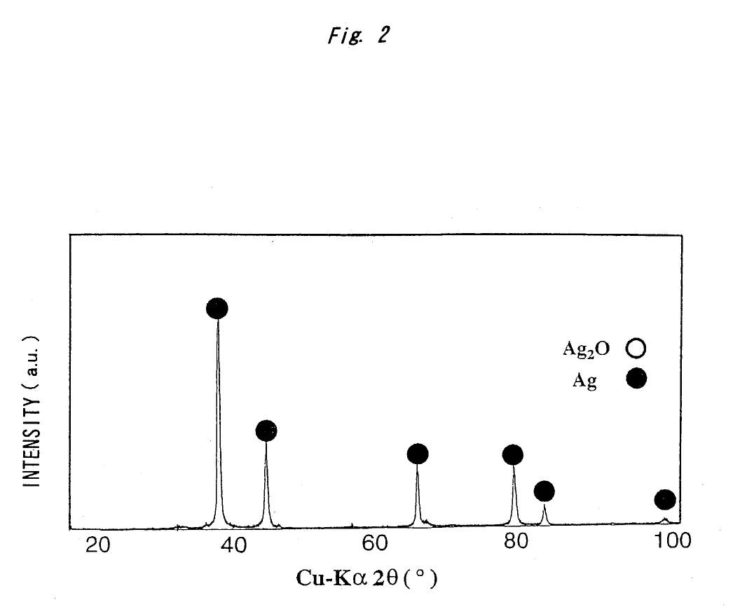

The thus-obtained coating film of the SiO₂ ceramics was analyzed by a X-ray diffraction method. A diffraction pattern is shown in FIG. 2. As FIG. 2 shows, it was found that a substance which coats the SiO₂ ceramic plate is Ag.

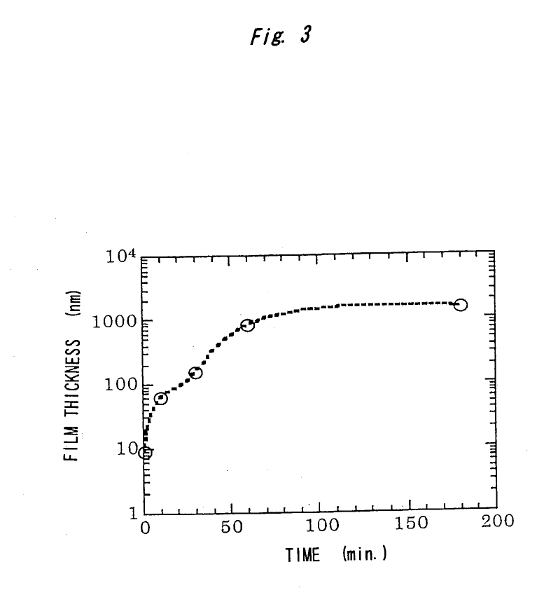

Further, a relationship between the period of ultrasonic wave irradiation time and film thickness at the time coating is performed is shown in FIG. 3. As FIG. 3 shows, it was confirmed that the film thickness can be controlled by changing the period of ultrasonic wave irradiation time and also that coating on the order of several nanometers can be realized by shortening the period of ultrasonic wave irradiation time.

Coating on the Si semiconductor wafer has been performed by similar procedures to those described above also. Same results as in the SiO₂ ceramic plate have been obtained.

### Example 2

BaTiO₃ dielectric ceramic powders and ZnO varistor ceramic powders were each individually used as a substrate. Ag₂O powders having a particle diameter of about 2 μm were used as powders of a metal oxide.

Firstly, the BaTiO₃ dielectric ceramic powders were put in ethanol. The resultant solution was added with Ag₂O powders and, then, heated up to 60° C. and, thereafter, irradiated by an ultrasonic wave of 500 W and 38 KHz. Next, the BaTiO₃ dielectric ceramic powders were removed from the solution and allowed to stand in a heating device for 30 minutes at 100° C. to stabilize a coating film.

Coating on the ZnO varistor ceramic powders has been performed by similar procedures to those described above also.

The thus-obtained coating film of the BaTio₃ dielectric ceramic powders and ZnO varistor ceramic powders according to the present invention were analyzed by the X-ray diffraction method. As a result, it was confirmed that a substance which coats each of the BaTio₃ dielectric ceramic powders and ZnO varistor ceramic powders is Ag.

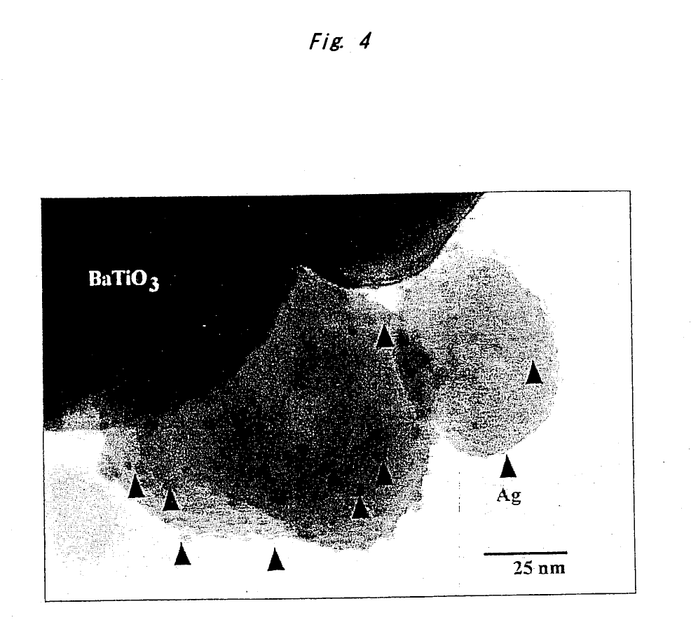

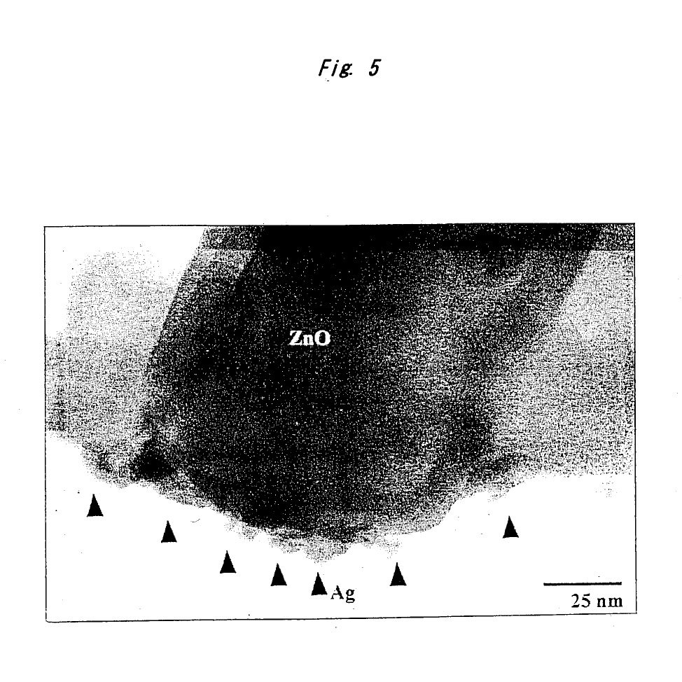

Further, a TEM observation was performed on a surface of each of the thus-obtained Ag-coated BaTio₃ dielectric ceramic powders and Ag-coated ZnO varistor ceramic powders. Shown in FIGS. 4 and 5 are the TEM images of respective materials. It was found that particles of Ag were uniformly dispersed on each surface of the BaTio₃ dielectric ceramic powders (FIG. 4) and ZnO varistor ceramic powders (FIG. 5) to form a coating film.

### Example 3

PdO was used as powders of a metal oxide in the above-described Examples 1 and 2, and coating of PdO was performed on each substrate. As a result, it was confirmed that, same as in a case in which AgO powders were used, a Pd coating film was uniformly formed on each substrate and thickness of such coating film was able to be controlled by the period of ultrasonic wave irradiation time.

### Example 4

A SiO₂ ceramic plate was used as a subsrate, PdO was used as powders of a metal oxide and, then, a forming process of a Pd film was observed by changing ultrasonic wave irradiation conditions.

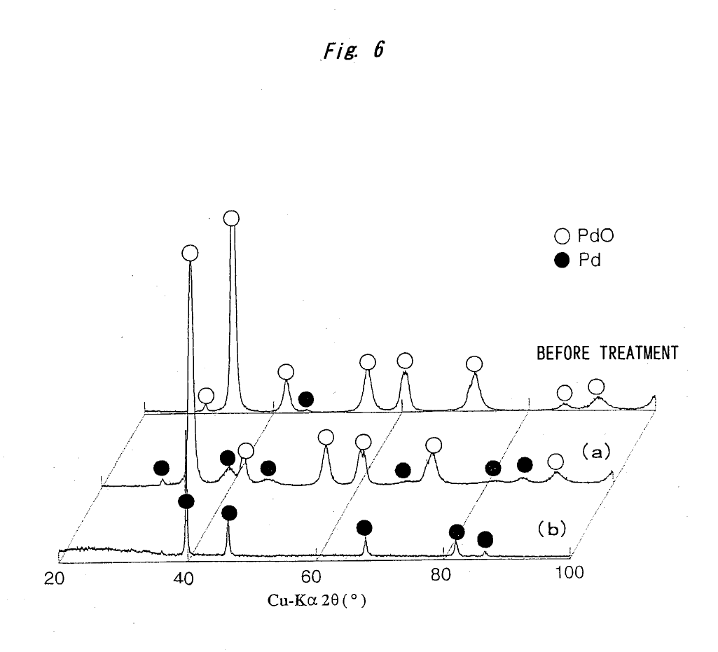

Firstly, the SiO₂ ceramic plate was rinsed with ethanol and the thus-rinsed Sio₂ ceramic plate was placed in ethanol and, then, added with PdO powders. Samples were prepared such that (a) the resultant mixture was irradiated by the ultrasonic wave of 500 W and 38 KHz at a low temperature (15° C.) for a short period of time and (b) the resultant mixture was irradiated by the ultrasonic wave of 500 W and 38 KHz at a relatively high temperature (60° C.) for a prolonged period of irradiation time and, further, allowed to stand in a heating device for 30 minutes at 100° C. to stabilize a coating film. Results of analyses of the PdO powders which have been used as a coating material and the samples (a) and (b) by the X-ray diffraction method are shown in FIG. 6. As a result, while PdO was partially present in a coating film formed in the sample (a), a coating film totally made of Pd was formed in the sample (b). From these results, it was confirmed that PdO has been reduced to be Pd by a sufficient ultrasonic irradiation.

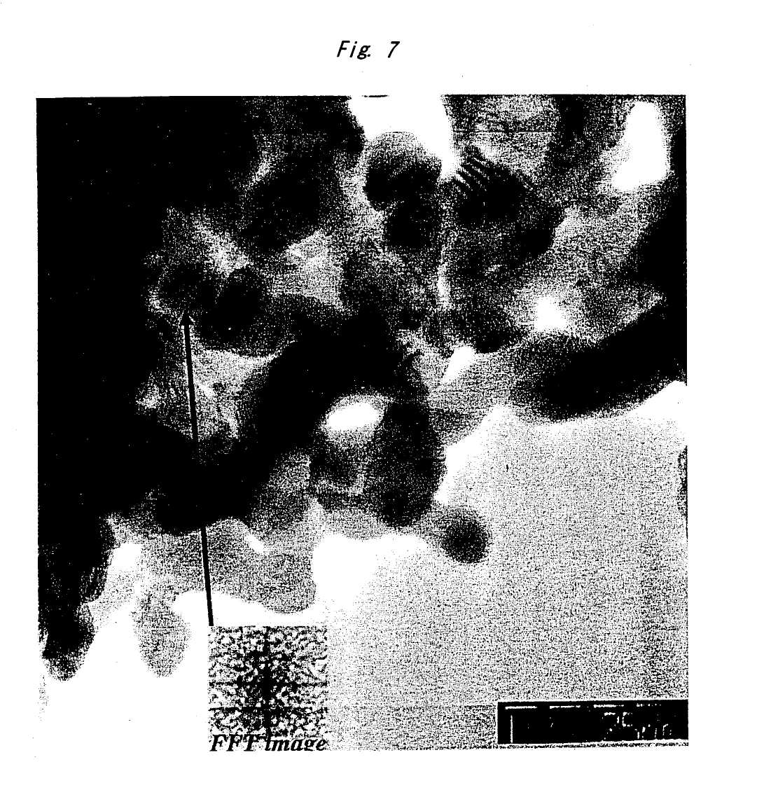

Further, in FIG. 7, shown is a high-resolution TEM (HRTEM) image of powders obtained by irradiating PdO powders by means of the ultrasonic wave. Also from FIG. 7, it was confirmed that Pd is formed by irradiating PdO powders by means of the ultrasonic wave.

### Example 5

Coating was performed in a same manner as in Examples 1 to 4 except that butanol was used instead of ethanol.

A ceramic plate coated with a metal was prepared in a same manner.

### Example 6

Coating was performed using each of PtO, Au₂O, Cu₂O, Cu(NO₃)₂ as an inorganic compound in a same manner as in Examples 1 to 5. The metallic coating was realized in a same manner.

### Comparative Example

When water was only used instead of alcohol in each of the above-described Examples 1 to 6, a metallic coating was not formed.

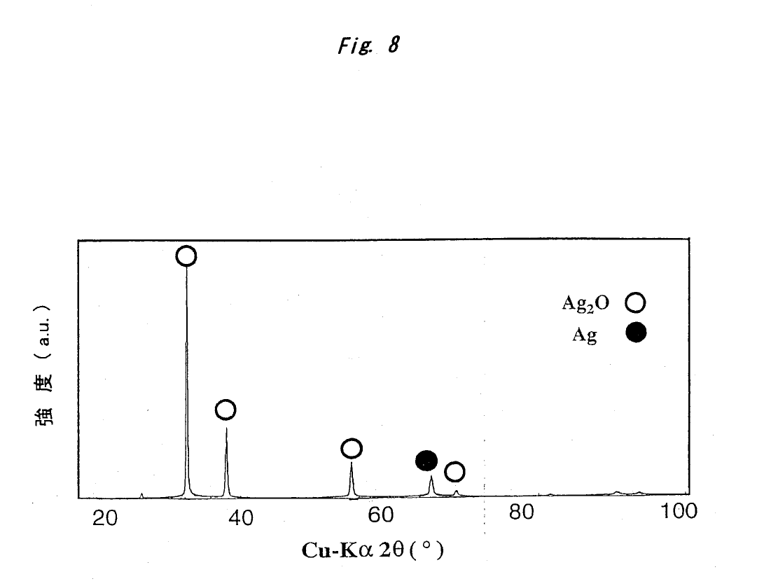

For example, when water was used as a medium and Ag₂O was used as powders of a metal oxide, as a result of analysis by X-ray diffraction after irradiation by the ultrasonic wave, for example, as shown in FIG. 8, powders of Ag₂O were not reduced. From this result, it was found that the metal oxide can not be reduced only by the ultrasonic wave and that it was necessary that the organic solvent is contained in the solution.

It goes without saying that the present invention is not limited to the above-described examples and that various embodiments are possible in details.

As has been described above in detail, a novel method which can uniformly coat a metallic film on various types of arbitrary substrates with a thickness on the order of from several nanometers to several thousand nanometers in a simple means without requiring a need for a means having such a multiple of restrictions as in the vacuum system, without caring about generation of a noxious gas or the like, and free from any restriction on a heating temperature or a selection of a material, and a material coated with a metal by the present method can be provided.

1. A metal coating method characterized by comprising the steps of:
dispersing powders of an inorganic compound in a liquid containing an organic solvent;
irradiating vibration or applying heat in a state in which a substrate is immersed in the liquid; and
forming a metallic film on the substrate.

2. The metal coating method as set forth in claim 1, wherein a liquid temperature is from 0° C. to 500° C.

3. The metal coating method as set forth in claim 1 or 2, wherein the organic solvent is an organic solvent which has a reducing property to the inorganic compound.

4. The metal coating method as set forth in any one of claims 1 to 3, wherein, after the vibration was irradiated or the heat was applied, the substrate is removed from the liquid and, then, heated to stabilize the metallic film.

5. The metal coating method as set forth in any one of claims 1 to 4, wherein the substrate is a metal (alloy) in bulk form or powder form, ceramics or an organic substance.

6. The metal coating method as set forth in any one of claims 1 to 5, wherein the inorganic compound is rich in reducing property to metals.

7. The metal coating method as set forth in any one of claims 1 to 6, wherein the inorganic compound is a reducing compound.

8. A material coated with a metal characterized by being produced by a method as set forth in any one of claims 1 to 7.

9. The material coated with the metal as set forth in claim 8, wherein a coated metal film is a functional film.
